(19) United States
(12) Patent Application Publication
(10) Pub. No.: US 2026/0257733 A1
(43) Pub. Date: Sep. 3, 2026

(54) ASSEMBLY OF A FLOOR COVERING PANEL OF A MOTOR VEHICLE

(71) Applicant: TREVES PRODUCTS,SERVICES & INNOVATION, Issy-Les-Moulineaux (FR)

(72) Inventors: Julien AGUILAR, Issy-Les-Moulineaux (FR); Alberto OVIEDO CARION, Issy-Les-Moulineaux (FR); Christophe GILLET, Issy-Les-Moulineaux (FR); Alicia LECOMTE, Issy-Les-Moulineaux (FR)

(21) Appl. No.: 19/165,323

(22) PCT Filed: Mar. 5, 2024
(86) PCT No.: PCT/EP2024/055747

§ 371 Date: Sep. 15, 2025

(30) Foreign Application Priority Data
Mar. 14, 2023 (FR) FR2302357

(51) Int. Cl. B62D 25/20; B29C 44/04; B29L 7/00; B29L 9/00; B62D 29/04

(52) U.S. Cl. CPC B62D 25/20; B29C 44/0476; B62D 29/04; B29K 2875/00; B29L 2007/002; B29L 2009/00

(57) ABSTRACT

The invention relates to an assembly (1) of a floor covering panel (2) of a motor vehicle, the assembly comprising the panel and at least two zones (3) for receiving the panel, the panel having at least two peripheral portions (4) mounted so as to bear on each of the receiving zones, respectively, and a median portion (5), the panel comprising a stiffening cellular core (6) defining a front side (7) and a back side (8), and two layers, front (10) and back (11), for reinforcing the core against bending, the layers being made up of entangled reinforcing fibres embedded in polyurethane foam, the surface density in the median portion (5) of the reinforcing fibres of each of the reinforcing layers being greater than the density in the peripheral portions (4).

The invention relates to an assembly of a floor covering panel of a motor vehicle, a panel of such an assembly and a method for producing such a panel.

It is known to produce an assembly of a floor covering panel of a motor vehicle, said assembly comprising said panel and at least two zones for receiving said panel which come from the body of said vehicle, said panel having at least two peripheral portions arranged along two of its opposite edges, said peripheral portions being respectively mounted so as to bear on each of said receiving zones, and a median portion extending between said peripheral portions without bearing, said panel comprising:
a stiffening cellular core generally in the form of a rectangular parallelepiped defining front side and a back side,
two front and back layers for reinforcing said core against bending, said layers being made up on entangled reinforcing fibres embedded in polyurethane foam, said reinforcing layers extending respectively over said front and back sides, said foam overmoulding said core so as to associate said reinforcing layers with said front and back sides.

The result is a panel with reinforcing layers spaced apart by the core acting as a spacer to produce a “beam effect”.

According to known embodiments, the surface density of the reinforcing fibres is substantially homogeneous over the entire surface of the reinforcing layers.

And it is necessary to provide a sufficient surface density of reinforcing fibres to enable the panel to have over its entire surface, and in particular in the median portion which has the lowest resistance to bending, a stiffness enabling it to receive a load without excessive bending.

However, such a surface density of fibres is unnecessary near the peripheral portions, which have a higher resistance to bending than the median portion.

The result is that the surface density of fibres is dictated by the resistance to bending which is required in the median portion, which leads to excessive use of fibres, with resulting disadvantages in terms of extra cost and extra weight of the panel.

The aim of the invention is to overcome these disadvantages.

To this end, and according to a first aspect, the invention proposes an assembly of a floor covering panel of a motor vehicle, said assembly comprising said panel and at least two zones for receiving said panel which come from the body of said vehicle, said panel having at least two peripheral portions arranged along two of its opposite edges, said peripheral portions being respectively mounted so as to bear on each of said receiving zones, and a median portion extending between said peripheral portions without bearing, said panel comprising:
a stiffening cellular core generally in the form of a rectangular parallelepiped defining a front side and a back side,
two front and back layers for reinforcing said core against bending, said layers being made up on entangled reinforcing fibres embedded in polyurethane foam, said reinforcing layers extending respectively over said front and back sides, said foam overmoulding said core so as to associate said reinforcing layers with said front and back sides,
   the surface density in the median portion of said reinforcing fibres of each of said reinforcing layers being greater than said density in the peripheral portions.

With the proposed arrangement, the surface density of the reinforcing fibres to be used is adapted according to the different portions of the panel, the median portion being provided with a greater quantity of fibres than the peripheral portions, which are lighter in fibres.

The result is a reduction in the cost and weight of the panel.

In particular, with the proposed arrangement, it is possible to produce panels of which the mass can be reduced by around 20 to 30%, while preserving their properties of resistance against bending.

According to other aspects, the invention proposes a panel of such an assembly and a method for producing such a panel.

Other features and advantages of the invention will become apparent from the following description, made with reference to the attached figures, in which:

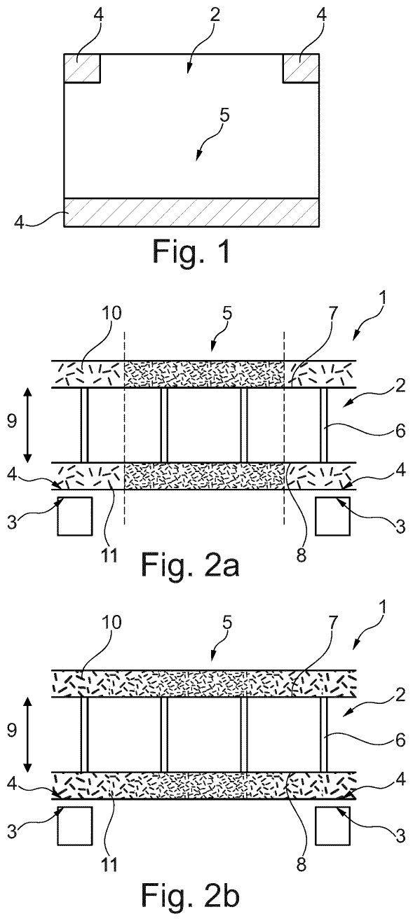

FIG. 1 is a schematic front view of a panel of an assembly according to one embodiment, said panel having various types of peripheral portions,

FIG. 2a and

FIG. 2b are schematic cross-sectional views of an assembly in which the surface density of the reinforcing fibres varies stepwise (FIG. 2a) and continuously (FIG. 2b).

With reference to the figures, an assembly 1 of a floor covering panel 2 of a motor vehicle—in particular a luggage compartment—is described, said assembly comprising said panel and at least two zones 3 for receiving said panel which come from the body of said vehicle, said panel having at least two peripheral portions 4 arranged along two of its opposite edges, said peripheral portions being respectively mounted so as to bear on each of said receiving zones, and a median part 5 extending between said peripheral portions without bearing, said panel comprising:
a cellular stiffening core 6 generally in the form of a rectangular parallelepiped defining a front side 7 and a back side 8,
two layers, a front layer 10 and a back layer 11, for reinforcing said core against bending, said layers being made up of reinforcing fibres—for example mineral fibres (glass, etc.) or vegetable fibres (flax, hemp, etc.)—which are entangled and embedded in polyurethane foam, said reinforcing layers extending respectively over said front and back sides, said foam overmoulding said core so as to associate said reinforcing layers with said front and back sides,
   the surface density in the median portion 5 of said reinforcing fibres of each of said reinforcing layers being greater than said density in the peripheral portions 4.

According to one embodiment, the core 6 has a thickness 9 generally of between 6 and 30 mm, the term “generally” meaning that this thickness can be reduced locally, in particular by compression, for example at the periphery of said core or in zones receiving fastening members.

According to the embodiment shown, the core 6 has a honeycomb structure, in particular based on cardboard or thermoplastic material.

In a variant not shown, the core 6 is in the form of a block made up of rigid foam, i.e. not elastically compressible.

According to various embodiments, the surface density of the reinforcing fibres in each of the reinforcing layers 10, 11 increases from the peripheral portions 4 to the median portion 5:
either in stages, as shown in FIG. 2A,
or continuously, as shown in FIG. 2B.

According to the embodiment shown in FIG. 1, at least one peripheral portion 4 (the one at the bottom of the figure) extends along one edge of the panel 2, so that said panel bears along said edge on the corresponding reception zone 3.

According to the same embodiment, two peripheral portions (those at the top of FIG. 1) are located respectively at the ends of an edge of the panel 2, so that said panel bears by two of its corners on the corresponding reception zones 3.

According to the embodiments shown in FIG. 2, the front 10 and back 11 reinforcing layers have the same distribution of reinforcing fibres in terms of surface mass, so as to provide symmetrical reinforcement against bending on the front and back of the panel 2.

In one embodiment, the surface density of the reinforcing fibres in each of the reinforcing layers 10, 11 is between 100 and 600 g/m².

In one embodiment, the surface density of the polyurethane in each of the reinforcing layers 10, 11 is between 100 and 600 g/m².

According to one embodiment, the surface density of the polyurethane is proportional—in particular in a 1/1 ratio—to that of the reinforcing fibres in each part 4, 5 of the panel 2, such an arrangement making it possible to ensure homogeneous impregnation of the reinforcing fibres by the polyurethane over the entire surface of the reinforcing layers 10, 11.

A panel 2 of an assembly 1 as described hereinabove is now described, said panel having at least two peripheral portions 4 arranged along two of its opposite edges and a median portion 5 extending between said peripheral portions, said panel comprising:
a stiffening cellular core 6 generally in the form of a rectangular parallelepiped defining a front side 7 and a back side 8,
two layers, front 10 and back 11, for reinforcing said core against bending, said layers being made up of entangled reinforcing fibres embedded in polyurethane foam, said reinforcing layers extending respectively over said front and back sides, said foam overmoulding said core so as to associate said reinforcing layers with said front and back sides,
   the surface density in the median portion 5 of said reinforcing fibres of each of said reinforcing layers being greater than said density in the peripheral portions 4.

According to an embodiment not shown, the panel 2 also comprises a front layer for covering, for example with carpet, the reinforcing front layer 10.

According to various embodiments, the covering front layer is glued to or overmoulded by the foam of the reinforcing front layer 10.

In an embodiment not shown, the reinforcing back layer 11 is covered with a covering back layer, for example of non-woven material.

In various embodiments, the covering back layer is glued to or overmoulded by the foam of the reinforcing back layer 11.

Finally, a method for producing such a panel 2 is described, said method comprising the following successive steps:
providing a cellular stiffening core 6 generally in the form of a rectangular parallelepiped defining a front side 7 and a back side 8,
depositing reinforcing fibres and a polyurethane foam precursor mixture on each of said faces, the surface density of said reinforcing fibres in the median part 5 being greater than said density in the peripheral portions 4,
placing the assembly in a mould,
waiting for the foam to expand so as to form reinforcing front 10 and back 11 layers, said foam overmoulding said core so as to associate said layers to said sides,
removing the assembly from said mould.

According to a first implementation of this method, not shown, the step of depositing reinforcing fibres and polyurethane foam precursor mixture on the front 7 and back 8 sides is carried out according to the following successive sub-steps:
placing a main sheet of reinforcing fibres on each of said faces, and at least one format—for example in the form of a medallion arranged in the median portion of said sides, or alternatively of a strip extending between two opposite edges of said sides—of an additional sheet of reinforcing fibres in the median portion 5 of said main sheet, so as to increase in stages the surface mass of said fibres in said median portion,
pouring a polyurethane foam precursor mixture onto each main sheet provided with its additional sheet.

According to a second implementation of this method, the step of depositing reinforcing fibres and polyurethane foam precursor mixture on front side 7 and the back side 8 is carried out by mixing reinforcing fibres with the polyurethane foam precursor mixture at the outlet of the casting head for said mixture, said casting head following a trajectory controlled by a robot, the quantity of fibres mixed with said mixture being introduced variably as a function of the position of said casting head on its trajectory so as to arrange the said fibres in an increased quantity in the median portion 5 of said sides, the distribution of the surface mass of said fibres being carried out either in stages or discontinuously.

It may also be possible to associate at least one covering layer on at least one reinforcing layer 10, 11, in particular by gluing or by overmoulding in the mould.

1. Assembly (1) of a floor covering panel (2) of a motor vehicle, said assembly comprising said panel and at least two zones (3) for receiving said panel which come from the body of said vehicle, said panel having at least two peripheral portions (4) arranged along two of its opposite edges, said peripheral portions being respectively mounted so as to bear on each of said receiving zones, and a median portion (5) extending between said peripheral portions without bearing, said panel comprising:
a stiffening cellular core (6) generally in the form of a rectangular parallelepiped defining a front side (7) and a back side (8),
two front (10) and rear (11) layers for reinforcing said core against bending, said layers being based on entangled reinforcing fibres embedded in polyurethane foam, the said reinforcing layers extending respectively over the said front and rear faces, the said foam overmoulding the said core so as to associate the said reinforcing layers with the said front and rear faces,
said assembly being characterised in that the surface density in the median portion (5) of said reinforcing fibres of each of said reinforcing layers is greater than said density in the peripheral portions (4).

2. Assembly according to claim 1, characterised in that the core (6) has a honeycomb structure.

3. Assembly according to claim 1, characterised in that the surface density of the reinforcing fibres of each of the reinforcing layers (10, 11) increases, from the peripheral portions (4) to the median portion (5):
either in stages,
or continuously.

4. Assembly according to claim 1, characterised in that at least one peripheral portion (4) extends along an edge of the panel (2), so that said panel bears along said edge on the corresponding reception zone (3).

5. Assembly according to claim 1, characterised in that two peripheral portions (4) are located respectively at the ends of an edge of the panel (2), so that said panel bears by two of its corners on the corresponding reception zones (3).

6. Assembly according to claim 1, characterised in that the front (10) and back (11) reinforcing layers have the same distribution of reinforcing fibres in terms of surface mass.

7. Panel (2) of an assembly according to claim 1, said panel having at least two peripheral portions (4) arranged along two of its opposite edges and a median portion (5) extending between said peripheral portions, said panel comprising:
a stiffening cellular core (6) generally in the form of a rectangular parallelepiped defining a front side (7) and a back side (8),
two front (10) and back (11) layers for reinforcing said core against bending, said layers being made up of entangled reinforcing fibres embedded in polyurethane foam, said reinforcing layers extending respectively over said front and rear sides, said foam overmoulding said core so as to associate said reinforcing layers with the said front and back sides,
said panel being characterised in that the surface density in the median part (5) of said reinforcing fibres of each of said reinforcing layers is greater than said density in the peripheral portions (4).

8. A method for producing a panel (2) according to claim 7, said method comprising the following successive steps:
providing a stiffening cellular core (6) generally in the form of a rectangular parallelepiped defining a front side (7) and a back side (8),
depositing reinforcing fibres and a polyurethane foam precursor mixture on each of the said faces, the surface density of the said reinforcing fibres in the median part (5) being greater than the said density in the peripheral portions (4),
placing the assembly in a mould,
waiting for the foam to expand so as to form reinforcing front (10) and back (11) layers, said foam overmoulding said core so as to associate said layers with the said sides,
removing the assembly from said mould.

9. Method according to claim 8, characterized in that the step of depositing reinforcing fibres and polyurethane foam precursor mixture on the front (7) and back (8) sides is carried out according to the following successive sub-steps:
arranging a main sheet of reinforcing fibres on each of said sides, and at least one format of an additional sheet of reinforcing fibres in the median portion (5) of said main sheet, so as to increase in stages the surface mass of said fibres in said median portion,
pouring a polyurethane foam precursor mixture onto each main sheet provided with its additional sheet.

10. Method according to claim 8, characterized in that the step of depositing reinforcing fibres and polyurethane foam precursor mixture on the front (7) and back (8) sides is carried out by mixing reinforcing fibres with the polyurethane foam precursor mixture at the outlet of the casting head for said mixture, said casting head following a trajectory controlled by a robot, the quantity of fibres mixed with said mixture being introduced variably as a function of the position of said casting head on its trajectory so as to place said fibres in increased quantity in the median portion (5) of said sides, the distribution of the surface mass of said fibres being carried out either in stages or discontinuously.
